(19) United States
(12) Patent Application Publication
(10) Pub. No.: US 2011/0041341 A1
(43) Pub. Date: Feb. 24, 2011

(54) Safety razor

(76) Inventor: Peter Louis Jurisich, Manhattan Beach, CA (US)

Correspondence Address: Peter L. Jurisich, 1541 19th St., Manhattan Beach, CA, 90266, US

(21) Appl. No.: 12/583,491

(22) Filed: Aug. 21, 2009

(51) Int. Cl. B26B 21/40

(52) U.S. Cl. 30/50

(57) ABSTRACT

A safety razor for wet shaving having two sets of blades cutting with opposite shaving stroke directions. This permits more efficient and effective shaving than with razors having blades that cut with strokes in one direction only.

### CROSS REFERENCE TO RELATED APPLICATIONS

Not applicable

### BACKGROUND

1. Field of Invention

This invention relates to improving wet shaving with safety razors.

2. Prior Art

None known by inventor.

### SUMMARY

Modern safety razors used for wet shaving have multiple blades that are mounted in swiveling housings. This allows the blades to maintain the proper cutting angle, which is typically obtained by pulling the razor handle along the direction of shaving. Then the razor is repositioned to start a new cutting stroke. This procedure is conducive to an occasional skin cut. The inventor has found that skin cuts can be avoided by not lifting the razor off the skin but pushing it back and forth along the line of the cutting stroke. This led to the present invention: having one or more blades mounted to cut in the direction opposite to those mounted as normally used. Thus, the razor will be cutting during both the pull and the push strokes. This makes for more efficient and effective shaving.

I claim:

1. A safety razor for wet shaving that has multiple cutting blades, some facing as conventional for the pulling stroke and some facing in the opposite direction for the pushing stroke.
